(19) United States
(12) Patent Application Publication
(10) Pub. No.: US 2009/0154987 A1
(43) Pub. Date: Jun. 18, 2009

(54) Protection element

(75) Inventors: Josef Glogger, Buchloe (DE); Oliver Wolff, Leinfelden Echterdingen (DE); Camiel de Smet, Tuggen (CH)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/316,096

(22) Filed: Dec. 8, 2008

(30) Foreign Application Priority Data
Dec. 17, 2007 (DE) 10 2007 055 835.1

(51) Int. Cl. E04B 1/41; F16B 13/14

(52) U.S. Cl. 403/11

(57) ABSTRACT

A protection element for use with a fastening element (8) anchorable in a hardenable mass and formed as a bowl-shaped member (11) having a circumferential outer wall (21); and a pass-through position (12) for the fastening element (8) and which defines a lead axis (13).

### BACKGROUND OF THE INVENTION

1. Field of the Invention

The present invention relates to a protection element for use with a fastening element anchorable in a hardenable mass and having a pass-through position for the fastening element and which defines a lead axis.

2. Description of the Prior Art

Fastening elements such as, e.g., anchor rods, steel studs, and reinforcing iron are anchored in existing constructional components or in bedrock in preliminary formed boreholes which are filled, e.g., with a hardenable mass such as, e.g., mortar or glue.

In particular, at an overhead job, during insertion of a fastening element in a borehole, which is filled with the hardenable mass, the forced-out mass can soil the environment and/or the operator.

German Utility Model DE 94 03 384 U1 discloses a protection element which is formed as splash-guard element that is pushed over a fastening element before the fastening element is inserted in a borehole which is filled with a glass cartridge containing a hardenable mass in form of a multi-component glue. Upon insertion of the fastening element in the borehole, a section of the protection element, which lies in a plane extending perpendicular or transverse to the lead axis, prevents glass chips and the excess mass, which can be forced out of the borehole upon insertion of the fastening element, from soiling the environment or the operator.

The drawback of the above discussed protection element consists in that the mass volume, which is caught by the section of the protection element is very small, and the removal of the protection element after the end of a setting process is rather difficult.

Accordingly, an object of the present invention is a protection element for use with a fastening element anchorable in a hardenable mass and which would have a receiving volume sufficient to catch the forced-out mass.

Another object of the present invention is a protection element that can be easily mounted on and dismounted from a fastening element.

### SUMMARY OF THE INVENTION

These and other objects of the present invention, which will become apparent hereinafter, are achieved by providing a protection element formed as a bowl-shaped member having a circumferential outer surface, and a pass-through position for the fastening element and which defines a lead axis.

By formation of the protection element as a bowl-shaped member, there is provided a receiving space which is limited by a bottom and at least an outer wall and which has a volume sufficient for receiving the hardenable mass that is forced out from a borehole during a setting process of the fastening element. The outer wall prevents sidewise flow of the forced-out mass, so that no soiling of the environment takes place. Thus, the operator is protected from the exiting hardenable mass during a setting process. The height of the outer wall defines, together with the sum of surfaces in the plane, the available receiving volume.

If a borehole is filled with a glass cartridge, the protection element according to the invention ensures the protection of the operator from the falling-out glass chips.

Advantageously, a distance of the outer wall from the lead axis increases in a direction of a bowl opening at least in some regions. Thus, the receiving volume, which is provided by the bowl-shaped protection element, widens toward the free end of the outer wall, so that the slightly sidewise sprayed mass, which leaves the borehole, is also reliably catched, and the danger of soiling of the environment and/or the operator is avoided to a most possible extent.

Advantageously, the outer wall extends radially and circumferentially relative to the lead axis, thus being arranged coaxially with the lead axis. With such round cross-section of the protection element, a simple handling of the protection element is ensured.

Advantageously, the outer wall is provided with reinforcing elements, which ensures an adequate stability and, e.g., with larger dimensions of the protection element, the protection element cannot inadvertently cave in or fall down.

Advantageously, the reinforcement elements are arranged radially and circumferentially with respect to the lead axis. Preferably, the reinforcement elements are formed as circumferential grooves. The grooves can be easily formed during manufacturing of the protection element and increase in advantageous manner the stability of the outer wall.

Preferably, at least the outer wall of the inventive protection member is made transparent. Thereby, at an overhead job, the entire setting process of the fastening element can be followed. More advantageously, the entire protection element is made transparent. Even more advantageously, the protection element is made of the plastic material, which ensures its economical production.

Advantageously, there is provided an inner wall, which extends centrally with respect to the lead axis and surrounds the pass-through position. The inner wall limits the receiving space of the bowl-shaped protection element inwardly. The inner wall surround the pass-through position in a chimney-like manner. Advantageously, the inner wall is coaxial with the pass-through position. The inner wall provides an inner limitation of the receiving space, which prevents, to a most possible extent, adhesion or clinging of the exiting, from the borehole in the region of the fastening element, mass to the fastening element. This, in turn, ensures a simple removal of the protection element from the fastening element when the setting process ends.

Advantageously, the pass-through position is formed in the inner wall, so that it is advantageously circumferentially closed by the free rim of the inner wall. At least the inner wall of the protection element is advantageously formed of an elastic or resilient material, so that the size of the pass-through position can be adapted to a corresponding diameter of the fastening element. Alternatively, or in addition, longitudinal slots can be formed in the inner wall, extending from the free end of the inner wall. This ensures a lamella-like deflection of the inner wall and an easy mounting or dismounting of the protection element on or off the fastening element as well as displacement of the protection element along the fastening element.

Advantageously, the distance of the inner wall from the lead axis decreases in the direction of the bowl opening, at least in some regions. Thus, the inner wall tapers, at least in some regions, toward its free end. The pass-through position is formed advantageously at the free end of the inner wall. When the protection element is pushed on the fastening element, the free rim of the inner wall engages circumferentially the outer profile of the fastening element and seals a possible gap between the free rim of the inner wall and the outer profile of the fastening element. After the end of the setting process of the fastening element, the protection element still can be easily removed, as no exiting mass can adhere to the outer profile of the fastening element in a region between the inner wall of the fastening element and the outer profile of the fastening element. Further, the protection element can be used with fastening elements having different outer diameters.

Advantageously, the region of the inner wall section, proceeding from the free end of the inner wall is provided with steps. The steps form cut-off marks which show the operator preferable diametrical regions for passing of a predetermined fastening element. Advantageously, the steps are matched to conventional outer diameters of the fastening elements. Dependent on the type of the fastening element and the selected outer diameter, the operator shortens the free end of the inner wall section, e.g., directly on the constructional site.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a plan view of a protection element according to the present invention in the direction of line I-I in FIG. 2;

FIG. 2 a cross-sectional view of the protection element along line II-II in FIG. 1; and

FIG. 3 a cross-sectional view illustrating the use of a protection element according to the present invention with a fastening element securable in a hardenable mass.

### DETAILED DESCRIPTION OF THE PREFERRED EMBODIMENT

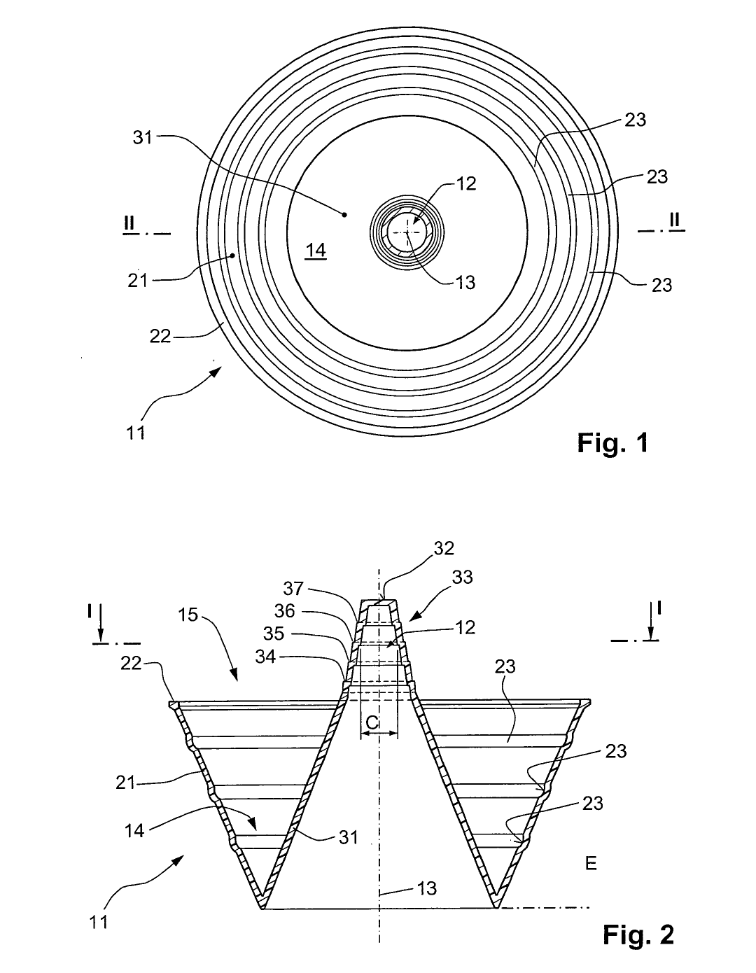

A protection element according to the present invention, which is shown in FIGS. 1-2, is formed as a bowl-shaped member 11 and has a pass-through position 12 that defines a lead axis 13 for a fastening element, not shown. The bowl shape of the protection element 11 provides a receiving space 14 for a hardenable mass that falls out from a borehole during a setting process. The receiving space 14 is limited by a radial circumferential outer wall 21 coaxial with the lead axis 13 and spaced therefrom. The distance of the outer wall 21 from the lead axis 13 continuously increases toward the bowl opening 15. The outer wall 21 has three reinforcing elements 23 which are formed as radially circumferentially extending grooves.

The protection element 11 further has a circumferential inner wall 31 coaxial with the lead axis 13 and surrounding the pass-through position 12. The inner wall 31 limits the receiving space 14 radially inwardly. The distance of the inner wall 31 from the lead axis 13 is continuously reduced in the direction of the bowl opening 15. The free end 32 of the inner wall 31 extends axially beyond the free end 22 of the outer wall 21, with a region 33 of the inner wall 31 projecting from the free end 22 of the outer wall 21. The projecting region 33 is formed with a plurality of steps 34-37.

By decreasing the length of the free end 32 of the inner wall 31, a through-opening for a fastening element is provided. If the inner wall 31, e.g., is cut off at the step 36, the obtained pass-through position would have a maximal diameter C which is smaller than an outer diameter of an insertable fastening element.

The entire fastening element 11 and, thus, the outer wall 21, are formed of a transparent plastic material.

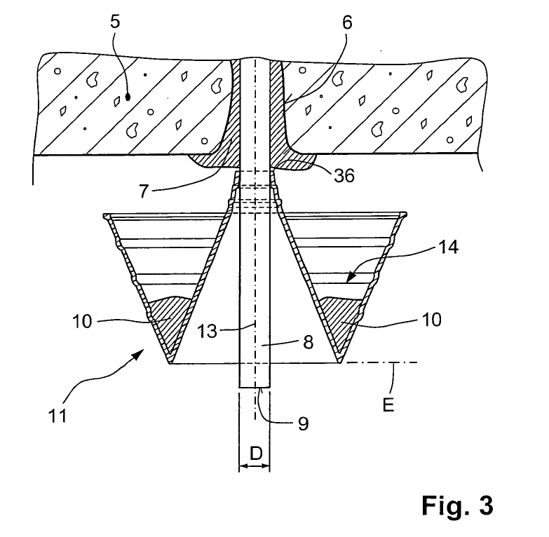

FIG. 3 illustrates the use of the protection element 11 with a fastening element 8 which is anchored in a hardenable mass 7. The fastening element 8 is formed as an anchor rod that has an outer diameter D of 10 mm. Before its use, the inner wall 31 of the protection element 11 has been cut off at the step 36, so that the diameter of the produced thereby through-opening for the fastening element 8 is smaller than the diameter D of the fastening element 8. A previously formed borehole 6 in the constructional component 5 is filled with a sufficient amount of the hardenable mass 7. Then, the protection element 11 is pushed over an end of the fastening element 8. Because of the diameter difference between the diameter of the through-opening and the outer diameter D of the fastening element 8, the free end of the inner wall 31 lies tightly on the fastening element 8 but nonetheless displaceably. Thereby, the clearance between the fastening element 8 and the inner wall 31 of the protection element 11 is sealed.

When, finally, the fastening element 8 is inserted in the borehole 6 already filled with the hardenable mass 7, the falling-out mass 10 is received in the receiving space 14 of the protection element 11. After completion of the setting process, the protection element 11 is removed from the fastening element 8 by being pushed in the direction of the free end 9 of the fastening element 8 and can be easily disposed. With the protection element 11 being transparent, the entire setting process can be followed.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A protection element for use with a fastening element (8) anchorable in a hardenable mass, the protection element comprising a bowl-shaped member (11) having a circumferential outer wall (21); and pass-through position (12) for the fastening element (8) and which defines a lead axis (13).

2. A protection element according to claim 1, wherein a distance of the outer wall (21) from the lead axis (13) increases in a direction of a bowl opening (15) at least in some regions.

3. A protection element according to claim 1, wherein the outer wall (21) extends radially with respect to the lead axis (13).

4. A protection element according to claim 1, wherein the outer wall (31) is provided with reinforcing means.

5. A protection element according to claim 4, wherein the reinforcing means is arranged radially and circumferentially with respect to the lead axis (13).

6. A protection element according to claim 1, wherein the outer wall (21) is transparent.

7. A protection element according to claim 1, wherein a circumferential inner wall (31) which extends centrally with respect to the lead axis (13) and surrounds the pass-through position (12), is provided.

8. A protection element according to claim 7, wherein a distance of the inner wall (31) from the lead axis (13) decreases in a direction of a bowl opening (15) at least in some regions.

9. A protection element according to claim 7, wherein a free end (32) of the inner wall (31) projects axially past a free end (22) of the outer wall (21).
